(19) United States
(12) Patent Application Publication
(10) Pub. No.: US 2010/0272997 A1
(43) Pub. Date: Oct. 28, 2010

(54) DENSIFICATION OF METAL OXIDES

(75) Inventors: Jackie Y. Ying, Singapore (SG); Jianyi Cui, Roslindale, MA (US)

Correspondence Address: WOLF GREENFIELD & SACKS, P.C., 600 ATLANTIC AVENUE, BOSTON, MA, 02210-2206, US

(73) Assignee: Massachusetts Institute of Technology, Cambridge, MA (US)

(21) Appl. No.: 12/682,048

(22) PCT Filed: Oct. 8, 2008
(86) PCT No.: PCT/US08/11586

§ 371 Date: Jul. 9, 2010

Related U.S. Application Data
(60) Provisional application No. 60/998,499, filed on Oct. 10, 2007.

(51) Int. Cl. B32B 5/16; C04B 35/64

(52) U.S. Cl. 428/402; 264/681

(57) ABSTRACT

The present invention relates to methods for manufacturing of fully densified nanocrystalline metal oxide ceramic materials at low sintering temperature. Methods of the invention involve dry compaction of a product resulting from hydrothermal treatment of metal ion suspensions and subsequent sintering. The present invention may produce ceramic bodies that exhibit nanocrystalline structural features with measured densities that are found to be extremely similar to the theoretical density.

### GOVERNMENT FUNDING

Research leading to various aspects of the present invention were sponsored, at least in part, by contract number N00014-01-1-0808 awarded by the Office of Naval Research. The U.S. Government has certain rights in the invention.

### FIELD OF INVENTION

The present invention relates to a process of dry compaction of hydrothermally treated suspensions for low temperature densification of metal oxides and the resulting product.

### BACKGROUND OF INVENTION

Nanostructured ceramics have been observed to demonstrate mechanical properties that may be useful for commercial purposes such as improved hardness, bending strength, and electrical properties. However, due to challenges in processing, production control of ceramics in the nanometer regime remains limited. A processing scheme that would produce controllably dense nanocrystalline ceramics is vital towards a systematic investigation of size-dependent properties of ceramics in the submicron regime and their commercial applications.

Frequently studied metal oxide ceramics include 3 mol % yttria-doped tetragonal zirconia (3YZ) and 8 mol % yttria-doped cubic zirconia (8YZ) not only because of their simple structures, but also because of their high mechanical strength and electrical conductivity properties, respectively. Tetragonal and cubic ceramics also require high sintering temperatures which may lead to increased grain growth. Reducing sintering temperature is a common practice for limiting grain growth in fully dense, single-phase ceramics. However, high pressures are typically required for removing pores that are trapped within the ceramic body at low sintering temperatures. Microstructural inhomogeneity (e.g., non-uniform particle packing and presence of agglomerates) is thought to be a major hurdle in ceramics densification. Removing microstructural non-uniformities have mainly been focused on liquid suspension deagglomeration of the powder suspension by casting or by electrochemical means in order to achieve improved particle packing in ceramic green bodies.

### SUMMARY OF INVENTION

The subject matter of the present invention involves, in some cases, interrelated products, alternative solutions to a particular problem, and/or a plurality of different uses of one or more systems and/or articles.

In one illustrative embodiment of the present invention, a method for synthesizing a densified metal oxide is provided. The method includes providing a metal hydroxide suspension; hydrothermally treating the metal hydroxide suspension, forming a metal oxide suspension; drying the metal oxide suspension and recovering a dried metal oxide green body; and, in the absence of a step of powder compacting between the hydrothermal treatment step and sintering, sintering the dried metal oxide green body by exposing the green body to a sintering environment at less than 1300° C. and less than 50 MPa to form a densified metal oxide ceramic at greater than 96% relative density.

In another illustrative embodiment of the present invention, a method for synthesizing a densified metal oxide is provided. The method includes providing a ceramic precursor composition; and sintering the ceramic precursor composition by exposing the composition to a sintering environment at less than 1300° C. and less than 50 MPa to form a densified metal oxide ceramic at greater than 96% relative density.

In a different embodiment of the present invention, a densified metal oxide is provided, comprising a nanostructured tetragonal or cubic material, wherein the nanostructured material has a relative density of at least 96% and an average grain size of less than 100 nm.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a process flow chart for synthesizing nanocrystalline metal oxide ceramics according to one embodiment of the present invention;

FIG. 2 is a graph of density versus sintering temperature for 3YZ (squares) and 8YZ (triangles) nanocrystalline metal oxide ceramics according to one embodiment;

FIG. 3 is a graph of grain size versus temperature for 3YZ (squares) and 8YZ (triangles) nanocrystalline metal oxide ceramics according to one embodiment;

FIG. 4 is a SEM image of 3YZ tetragonal nanocrystalline metal oxide ceramics sintered at temperatures of (a) 1100° C., (b) 1200° C., and (c) 1300° C.

FIG. 5 is a SEM image of 8YZ cubic nanocrystalline metal oxide ceramics sintered at temperatures of (a) 1150° C., (b) 1250° C., (c) 1300° C. and (d) 1400° C.

### DETAILED DESCRIPTION

The present invention relates generally to processing of ceramic precursor compositions toward formation of ceramic articles under conditions that are milder, and/or temperatures that are lower relative to the general state of the art. In specific embodiments, the invention involves the surprising discovery that certain ceramic precursor materials can be processed with little or no powder compacting prior to sintering. Aspects of the present invention generally relate to ease of hydrothermal processing of nanocrystalline metal oxide ceramics at low temperatures for tetragonal and cubic yttria-doped zirconia ceramics and related metal oxides such as aluminum oxide, yttrium oxide, cerium oxide, titanium oxide, silicon dioxide, boric oxide, potassium oxide, sodium oxide, magnesium oxide, ferrous-ferric oxide, zinc oxide, zirconium oxide, barium oxide, lithium oxide, lead oxide, strontium oxide, and other ceramic materials processable in accordance with the invention.

In one aspect of the present invention, the ceramic grain size is systematically controllable in a range between approximately 50 nm and approximately 5 microns, different embodiments of the range which will be described below. As a result, it is possible to determine various mechanical, electrical and other properties of these materials as a function of grain size.

As presented herein, a nanocrystalline material should be considered as a crystalline solid with dimensions that are measured in nanometers in which constituent atoms form an array of periodically repeating points, packed in a regularly ordered pattern that extends in three independently spatial directions. The repeating crystalline pattern may define any structure that makes up a lattice or a unit cell. Several different crystalline patterns exist and may apply to the present invention, including but not being limited to cubic, tetragonal, trigonal, hexagonal, orthorhombic, monoclinic, and/or triclinic systems. An example of a crystal lattice is the cubic crystal system which is typified by a unit cell that takes on the shape of a cube. Another example of a crystal lattice includes the tetragonal crystal system which results from the stretching of a cubic lattice along one of the lattice directions so that the unit cell is characterized by a rectangular shape.

Nanocrystalline ceramic materials are useful in a variety of ways. Some examples of such applications include, but are not limited to, construction bricks, tiles, pipes, porcelain, pottery, stoneware, earthenware, semiconductors, and superconductors.

As noted, ceramic precursor compositions are processed in accordance with the invention in new and surprising ways. As used herein, the term “ceramic precursor composition” refers to a composition that, when appropriately treated (e.g., sintered), can form a full density ceramic structure or ceramic-containing structure. A ceramic precursor composition can have one or more different ceramic components. The ceramic component may be in the form of a metal hydroxide suspension, a metal oxide suspension, a metal oxide green body, or the like. That is, this term can refer alternatively to various compositions that exist at various steps in the formation of a densified ceramic article, prior to final densification of the article. For example, a precursor may comprise at least one type of ceramic particle. In some cases, the ceramic precursor composition may comprise at least two types of ceramic particles. In some embodiments, the ceramic component may be in the form of a liquid precursor, including pre-ceramic suspensions and/or solutions (e.g., a solvent comprising dissolved matter, non-particulate liquids). It is also possible for one or more ceramic components to contain a metal, such that the resulting ceramic body may be a metal-ceramic composite (or cermet). In some cases, the metal may be a metal particulate.

In one aspect of the present invention, starting metal hydroxide precursor materials are provided for the process of forming nanocrystalline metal oxide ceramics to occur. In some embodiments, a suitable base solution or buffer is provided. Examples of possible base solutions that may be incorporated in as starting metal hydroxide precursor materials include, but are not limited to any hydroxide salt, for example, ammonium hydroxide, tetraethyl ammonium hydroxide, or any other suitably related base solution. In other embodiments, depending on the type of metal oxide ceramic that is ultimately desired, various suitable metal ions may also be incorporated into the metal hydroxide precursor mixture. Examples of metal ions that may be included as precursors in any suitable salt solution includes, but is not limited to, aluminum, yttrium, cerium, titanium, silicon, boron, potassium, sodium, magnesium, iron, zinc, zirconium, barium, lithium, lead, strontium, or any other suitable metal hydroxide precursor.

In another aspect of the present invention, suspensions are provided, particularly metal hydroxide suspensions and metal oxide suspensions. What is meant by a “suspension” is a heterogeneous mixture where an internal phase of particles of at least one component are dispersed throughout an external phase. The internal phase may or may not settle over time if left undisturbed, depending on the size of the particles and their solvation characteristics. In a suspension, while the mixture remains heterogeneous, it is possible for a portion of the internal phase particles to at least partially dissolve within the external phase. It should be understood that emulsions and colloidal mixtures are also considered to be suspensions. Herein, a metal hydroxide suspension is meant to be a suspension that is substantially made up of a metal hydroxide composition. Similarly, a metal oxide suspension is meant to be a suspension that is substantially made up of a metal oxide composition.

In forming a metal hydroxide suspension, precursors are often precipitated or co-precipitated in a process that typically involves the salt compounds of two or more desired precursors that are dissolved in aqueous solutions and subsequently precipitated from solution by an environmental adjustment. In some cases, the environmental adjustment may be any suitable change in pH, temperature, agitation, or other suitable technique, depending on the nature of the precursors involved.

In another aspect of the present invention, a hydrothermal method is used as part of the technique in producing ultrafine ceramic material with uniform size and pore distributions. The hydrothermal method involves an aqueous chemical process for preparing anhydrous crystalline ceramic materials under high temperature and pressure for a preferred time period. In this manner, poorly ordered precursors in a coprecipitated mixture are heated resulting in an increased level of solubility and crystallinity. Eventually, formation of a more stable oxide phase occurs from a sufficient concentration of components existing in solution. A wide range of non-stirred pressure vessels, reactors, or autoclaves suitable for the hydrothermal process step may be used. In one embodiment of the present invention, the temperature under which a step of hydrothermal synthesis occurs may range from approximately 100° C. to approximately 150° C. In another embodiment, the temperature under which a step of hydrothermal synthesis occurs may range from approximately 100° C. to approximately 180° C. In a further embodiment, the temperature under which a step of hydrothermal synthesis occurs may range from approximately 100° C. to approximately 250° C. Indeed, the temperature range for which hydrothermal synthesis may occur can range from just over 100° C. to approximately 375° C.

As increased pressure is considered to be an inherent aspect of hydrothermal synthesis as the temperature is raised within a pressure vessel, hydrothermal synthesis may occur under various pressure ranges. In one embodiment of the present invention, the pressure during hydrothermal synthesis may range from approximately 1 MPa to approximately 5 MPa. In another embodiment, the pressure under which hydrothermal synthesis occurs may range from approximately 5 MPa to approximately 15 MPa. In a further embodiment, the pressure under which hydrothermal synthesis occurs may range from approximately 15 to approximately 25 MPa. Indeed, the pressure range for which hydrothermal synthesis may occur can range from 1 MPa to approximately 50 MPa. It is also to be understood that in another embodiment, the inherent pressure for which hydrothermal synthesis may occur at around 180° C. within a pressure vessel may also be incorporated in the process step.

Holding time is another aspect that is incorporated into a step of hydrothermal synthesis. In one embodiment of the present invention, the time period during which hydrothermal synthesis occurs may range from approximately 2 hours to approximately 8 hours. In another embodiment, the time period during which hydrothermal synthesis occurs may range from approximately 8 hours to approximately 24 hours. In a further embodiment, the time period during which hydrothermal synthesis occurs may range from approximately 24 hours to approximately 72 hours. Indeed, the time period range for which hydrothermal synthesis may occur can range from approximately 2 hours to approximately 108 hours.

In addition to temperature, pressure, and holding time period, pH may also contribute to the viability of the hydrothermal step as well. Regarding the pH under which hydrothermal synthesis occurs, in one embodiment of the present invention, the pH may be approximately 10.5. In another embodiment, the pH may be approximately 10. In further embodiments of the present invention, the pH during hydrothermal synthesis may range anywhere between approximately 7.5 and approximately 13.

A step of drying can be performed subsequent to the hydrothermal synthesis. In some embodiments, drying may be performed in an oven that may be set between a range of approximately room temperature and approximately 150° C. In more embodiments, drying may be performed at any of the drying temperatures listed but with added air circulation. This air circulation could occur in the form of a fan, a vent, or any suitable indirect air flow. In further embodiments, drying may be performed at around room temperature where a dried metal oxide intermediate is recovered, it is formed into a metal oxide shape suitable for sintering, and then it is sintered into a nanocrystalline ceramic. In further embodiments, drying may occur over a suitable time period that allows for water to be substantially removed from the metal oxide material.

In some aspects of the present invention, a green body is produced as an intermediate component while manufacture of a nanocrystalline metal oxide ceramic occurs. Typically before sintering hardening of a metal oxide ceramic takes place, a roughly held together object, called a “green body” is made. In the manner presented herein, a “green body”, is an intermediate that is formed during the processing of a ceramic material that is not yet sintered and not yet considered to be a finished ceramic by one of ordinary skill in the art. As the green body is sintered, pores close up and the object tends to shrink, resulting in a more dense, stronger material. At times, the green body is pressed in order to enhance densification as well as possibly reduce sintering time and/or temperature. In some embodiments of the present invention, a suitable amount of mechanical pressure is applied to the green body during sintering. The mechanical pressure may be isostatic in nature and may cover any of suitable range including approximately 50 MPa to approximately 10 GPa. In other embodiments, there is no added pressure applied to the green body during sintering.

Various screening tests may be employed during or after the process in order to check for sufficient density, as part of a process also of selecting suitable precursor compositions for use in the invention. In one embodiment, for a good indication of whether the metal oxide is sufficiently dense after sintering, once sintering has been completed, the sintered ceramic can be examined by one of ordinary skill in the art for a reasonable level of translucency. In this regard, if the sintered ceramic is essentially translucent, then the ceramic may be considered to be sufficiently dense as there is less opportunity for light to be scattered by the physical presence of pores distributed throughout the material. In another embodiment of the present invention, after sintering, it is possible to perform any suitable density test in order to assess overall density. One example of a technique for measuring density is through Archimedes' principle where the mass may be measured through an appropriate scale, and volume may be measured from the relative displacement of a liquid when the object is submerged. Any suitable liquid may be used for volume measurement including, but not limited to, water, methanol, and mercury. In this regard, the actual measured density of the nanocrystalline ceramic material may be compared to the theoretical crystalline density and calculated as a relative density percentage.

In another aspect of the present invention, a powder compaction step that is a common process step used in the preparation of sintered metal oxide ceramics is absent or, if present, used at a level less than would have been expected to be necessary based on knowledge in the art prior to the present invention. Following hydrothermal treatment, the result of drying the metal oxide suspension is typically powder compacted through grinding or other desired means. Subsequently after the step of compacting, the metal oxide intermediate is formed into any desired shape, and it is sintered. In some cases, in typical prior art arrangements, cold isostatic or uniaxial pressing also occurs before sintering at a range that is not limited to but ranging between approximately 1 MPa to approximately 1 GPa. However, in some embodiments of the present invention, following hydrothermal treatment, a step of powder compacting is removed from the overall process, bypassing the complexities that result from powder compaction. In other embodiments, following hydrothermal treatment, the metal oxide suspension may be washed and then dried, as described above, to recover a metal oxide intermediate that is ready for formation into a metal oxide green body and subsequent sintering into a nanocrystalline ceramic. In this respect, once the metal oxide intermediate is ready for sintering, it is called a green body. Suitable washing fluids include, but are not limited to, water, ethanol, or any other suitable non-caustic fluid. In further embodiments, following hydrothermal treatment, the metal oxide suspension is directly dried to recover a metal oxide green body and subsequently sintered into a nanocrystalline ceramic.

As discussed previously, the formation of undesirable inhomogeneities through common process steps in ceramic development typically lead to difficulties in densification and grain growth during sintering at low temperatures. In another aspect of the present invention, it is possible to mostly avoid the formation of inhomogeneities through largely eliminating steps of compacting or forming, allowing for full densification and limited grain growth to occur at low temperatures. In one embodiment, the temperature used for sintering nanocrystalline ceramic oxides may be less than or approximately 1400° C. In another embodiment, the temperature used for sintering nanocrystalline ceramic oxides may be less than or approximately 1300° C. In a further embodiment, the temperature used for sintering nanocrystalline ceramic oxides may be less than or approximately 1200° C. In yet another embodiment, the temperature used for sintering nanocrystalline ceramic oxides may be less than or approximately 1100° C. In a further embodiment, the sintering temperature used may be less than or approximately 1000° C. Indeed, in different embodiments, the sintering temperature used may be less than or approximately 900° C. It may be noted that the maximum temperature of standard furnaces typically ranges up to 1200° C. In practice, furnaces that require temperatures in excess of 1200° C., especially for sintering, can still be used although they tend to be complex in operation and quite expensive. Low temperature sintering, as presented herein, generally allows for easier handling and greater flexibility in use.

In a further aspect of the present invention, sintering occurs at normal pressure levels. Sometimes, relatively high pressures are present during sintering processes, resulting in a reduction of the system diffusion length at elevated temperatures in order to limit grain growth while achieving high density within the material. In one embodiment, pressures less than 250 MPa are present during sintering. In another embodiment, pressures less than 150 MPa are present during sintering. In a further embodiment, pressures less than 100 MPa are present. In yet another embodiment, pressures less than 50 MPa are present. Indeed, in other embodiments, it is possible to sinter at atmospheric pressure levels.

The grain size for nanocrystalline ceramics is a vital determination of their overall properties. In one embodiment of the present invention, the average grain size for the nanocrystalline ceramic material is less than approximately 1 micron. In another embodiment, the average grain size for the nanocrystalline ceramic material is less than approximately 500 nm. In a further embodiment, the average grain size for the nanocrystalline ceramic material is less than approximately 200 nm. In yet another embodiment, the average grain size for the nanocrystalline ceramic material is less than approximately 100 nm. Indeed, the average grain size for the nanocrystalline ceramic material could also be less than approximately 50 nm.

In another aspect, the grain size for nanocrystalline ceramics may be tunable within a range of grain sizes according to variation of different parameters such as, but not limited to, temperature and holding time. In some embodiments, the ceramic grain size is systematically controllable in a range between approximately 50 nm and approximately 5 microns. In other embodiments, the ceramic grain size is systematically controllable in a range between approximately 50 nm and approximately 1 micron. In further embodiments, the ceramic grain size is systematically controllable in a range between approximately 50 nm and approximately 500 nm. In even further embodiments, the ceramic grain size is systematically controllable in a range between approximately 50 nm and approximately 100 nm. In this manner, the greater the sintering temperature, the larger the ceramic grain size will be. Similarly, the longer the holding time at a certain sintering temperature, the larger the ceramic grain size will be.

There are several suitable techniques for which grain size may be measured. One possible manner in which grain size may be measured includes scanning electron microscopy where grains are individually imaged, the approximate diameter is estimated, and an average grain size is calculated. Transmission electron microscopy or atomic force microscopy are other suitable method that may be used to estimate grain size dimensions. Indeed, the manner in which grain sizes may be estimated should not be limited in scope to the techniques presented in this specification.

The relative density that results from a comparison of the actual measured density in nanocrystalline ceramics to the theoretical density is an important aspect for their consistency and overall performance. In this respect, the measured density is considered to be the mass per volume of the material as measured through Archimedes' principle, as discussed above. The theoretical density is considered to be the mass of atoms in one unit cell per unit cell volume in a single crystal. The relative density is considered to be the ratio between the measured density and the theoretical density. In one embodiment, the relative density of the nanocrystalline ceramic material is greater than 95%. In another embodiment, the relative density of the nanocrystalline ceramic material is greater than 96%. In a further embodiment, the relative density of the nanocrystalline ceramic material is greater than 97%. In yet another embodiment, the relative density of the nanocrystalline ceramic material is greater than 98%. In yet a further embodiment, the relative density of the nanocrystalline ceramic material is greater than 99%.

In one embodiment of the present invention, green body densities may range between approximately 45-55%. In this respect, the agglomeration of grains, which are formed naturally during the drying process due to the capillary force associated with water vaporization, may aid in achieving a narrow pore size distribution in the green body. Although the invention does not require pressure to achieve good densities, in some embodiments, mild pressure can be applied. Specifically, in some embodiments a powder compact may be sintered at suitable temperatures under uniaxial pressure in a hot press under vacuum (Materials Research Furnaces Inc.). Application of pressure during sintering through hot press may be used in closing residual pores and suppressing grain growth. In some embodiments of the present invention, hydrothermally treated tetragonal and cubic yttria-zirconia metal oxide powders are subjected to hot pressing under suitable pressures for 1 hour at 1100° C. and 1150° C., respectively. In one embodiment, a pressure of 150 MPa was used to fully densify tetragonal yttria-zirconia at 1100° C. and cubic yttria-zirconia at 1150° C., corresponding to grain sizes of ˜75±3 nm for the tetragonal yttria-zirconia and ˜78±4 nm for the cubic yttria-zirconia ceramics. In other embodiments, pressures of 100 MPa may be used to aid in full densification of metal oxide ceramics. In further embodiments, pressures of 200 MPa may be used to aid in full densification of metal oxide ceramics. It should be understood that in other embodiments, a dried compact, as opposed to a powder compact, may be sintered at ambient pressure without need for additional complexities in arrangement or application of mechanical pressure, such as that described for a powder compact, resulting in a fully dense nanocrystalline ceramic material after hydrothermal treatment, drying, and subsequent sintering.

In various embodiments, 3 mol % tetragonal yttria-doped zirconia and 8 mol % cubic yttria-doped zirconia were formed with consideration to their mechanical and electrical properties. It should be understood that the molar ratios of yttria-doped zirconia, namely 3 mol % (3YZ) and 8 mol % (8YZ), are approximate in nature. For example, it is not necessary for the molar ratio of a nanocrystalline tetragonal yttria-doped zirconia ceramic to be exactly 3 mol %, but it could differ by more than 1.0 mol % greater or less than 3 mol %, ranging from approximately 2 mol % to approximately 4 mol % as long as the crystalline structure is tetragonal in nature. In a similar manner, the molar concentration for a nanocrystalline tetragonal yttria-doped zirconia ceramic end product does not have to be 3 mol % throughout the entire manufacturing process. Indeed, the relative amounts of initial ingredient materials could give rise to any suitable concentration at any point during production. In this regard, the variance in molar ratio during or after production of nanocrystalline cubic yttria-doped zirconia material or any of the other metal oxide ceramics described above is also an aspect of the present invention. With respect to a nanocrystalline cubic yttria-doped zirconia ceramic material, the molar ratio may range from approximately 6 mol % to approximately 14 mol % and still be cubic in nature, not being strictly limited to a molar ratio of 8 mol %.

In some embodiments, tetragonal and cubic nanocrystalline ceramic recovered after sintering achieved greater than about 99% density at sintering temperatures of about 1100° C. and about 1150° C., respectively. In comparison, commercial powders which were cold isostatically pressed would typically result in a density less than about 75% at a sintering temperature of about 1200° C. Commercial powders would reach full densification (−99% density) at temperatures in excess of about 1400° C. In another comparison, powder compacted samples which were sintered after compaction by hydraulic press and cold isostatically pressed would reach a density plateau at approximately about 95% when sintered at about 1100° C. In some aspects, the ability to sinter particles obtained from hydrothermal synthesis at low temperatures, without any grinding or compacting after hydrothermal synthesis, allows for secondary porosity as a result of compact processing to be eliminated. In this respect, preventing formation of large pores (typically greater than or approximately 50 nm) that may exist initially in a green body is achieved. As a result, fully dense nanocrystalline ceramics may be attained at a relatively low sintering temperature without significant grain growth.

Narrowing of the pore size distribution is also an aspect that may occur as a result of drying immediately after hydrothermal treatment, as opposed to undergoing a step of powder compaction or grinding after hydrothermal treatment. In one embodiment, after treatment at about 900° C., cubic powder compact samples showed a broad pore size distribution with 80% of the pore sizes ranging from approximately 10 to approximately 50 nm, while the dried compact demonstrated a sharp pore size distribution of less than 20 nm. As a result, the dried compact could be completely densified in one step as the sintering temperature is raised from 900° C. to 1150° C. as the narrow pore size distribution of the dried compact green body would not easily give rise to significant pore growth during sintering at higher temperatures.

Pore size may be calculated through any suitable technique, including but not limited to measuring the adsorption and desorption of inert gases on a solid surface. In some embodiments, pore size distributions were measured through a Brunauer, Emmett, and Teller (BET) machine where pore sizes are assessed through the adsorption and desorption of gas phenomena mentioned above. Other examples of measuring pore sizes include techniques such as small angle X-ray scattering, porosimetry (using mercury or any other suitable non-wetting liquid), transmission electron microscopy, as well as other suitable surface area or pore size analyzers.

### Example 1

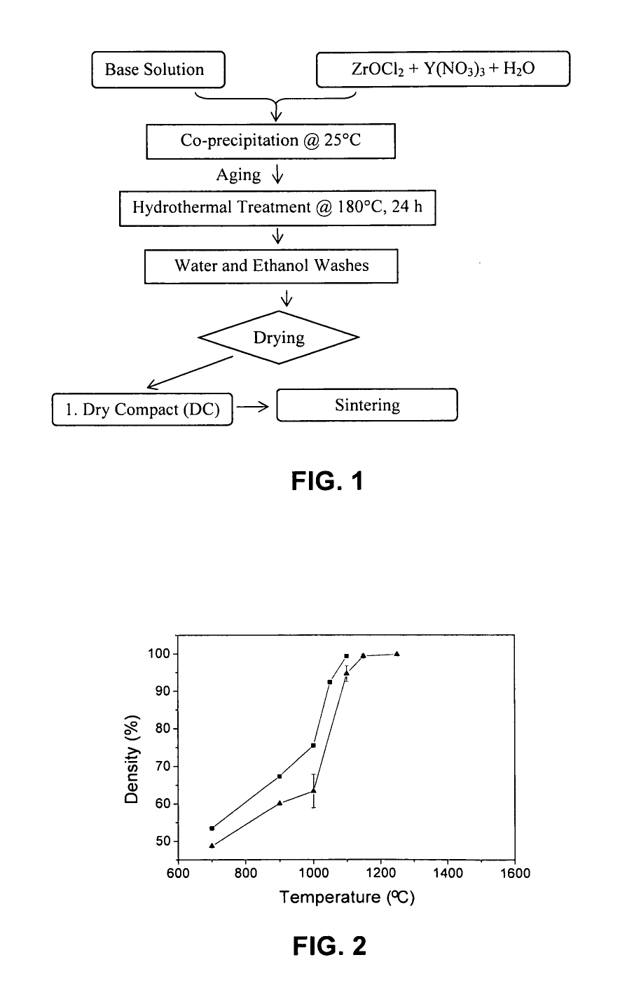

One example of the present invention will now be presented. FIG. 1 describes the process flow steps for synthesizing 3YZ and 8YZ nanocrystalline metal oxide ceramics. An ammonium hydroxide base solution was combined with an aqueous solution of 0.4 M zirconium oxide chloride and yttrium nitrate to synthesize a 3YZ or 8YZ metal hydroxide suspension through chemical co-precipitation. Whether 3YZ or 8YZ is produced depends on how the initial precursor ratio is controlled. The metal hydroxide suspension was then hydrothermally treated at 180° C. for 24 hours in a suitable pressure vessel chamber at pH approximately 10.5, giving rise to a metal oxide suspension with nanocrystalline particles that exhibit high crystallinity. The precipitate of the metal oxide suspension was then collected via centrifugation, and washed three times in deionized (DI) water. The resulting metal oxide suspension was then dried directly to form a dried compact in the absence of a step of powder compacting. A formed dried compact metal oxide green body was then exposed to a sintering environment ranging from 800 to 1300° C. at atmospheric pressure levels.

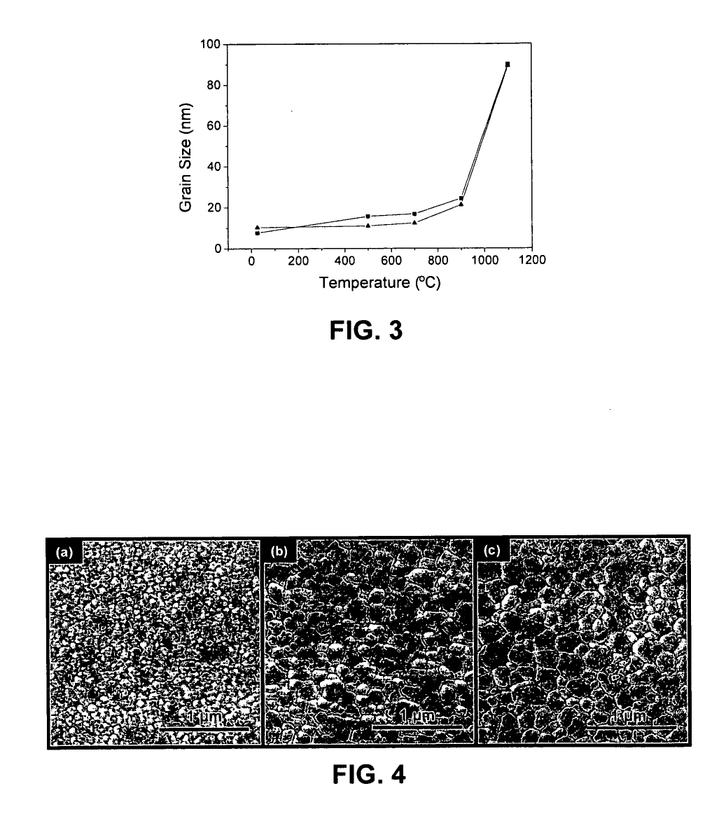

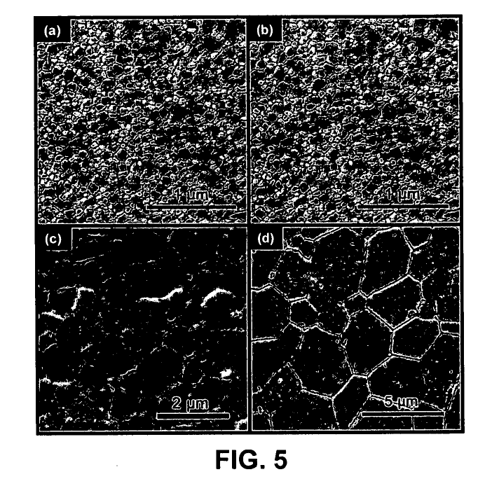

The relationship between density and sintering temperature for 3YZ and 8YZ nanocrystalline metal oxide ceramics is plotted shown in FIG. 2. Here, the density of both the nanocrystalline 3YZ and 8YZ ceramics consistently increased from 700° C. to 900° C. with a significant jump from 1000° C. to 1100° C. where the nanocrystalline materials exhibited close to full densification at ˜99%. With respect to the grain sizes achieved in the ceramics studied, a graph of grain size versus temperature for 3YZ and 8YZ nanocrystalline metal oxide ceramics is given in FIG. 3. In this example, the grain size increases slowly before sintering, and at the temperature range from 900° C. to 1100° C., when sintering ensues, a considerable jump occurs from approximately 20 nm to approximately 90 nm. Also shown in FIGS. 4 and 5, ultrafine grain sizes averaging ˜87±2 nm for 3YZ and ˜85±16 nm for 8YZ, respectively, were retained at relatively low sintering temperatures, around 1100° C. In a different aspect presented herein, nanocrystallinity may also be tunable with respect to grain size depending on the processing technique. In this example, dried compact samples of 3YZ and 8YZ were subjected to thermal treatment at temperatures beyond full densification. FIG. 4 shows results upon heating to 1200° C. for 3YZ oxides with grain growth up to ˜146±17 nm. Further grain growth occurred to ˜180±31 nm upon heating to 1300° C. As depicted in the images in FIG. 4, grains are polyhedral in shape with variations in their overall diameters. In FIG. 5, increased thermal treatment of 8YZ exhibited significant grain growth to ˜537±34 nm when heated to 1250° C. Upon increased temperature treatment to 1300° C., grain growth continued on to ˜819±71 nm. At 1400° C. sintering temperature, grain growth increased all the more to ˜2.8±0.4 microns. Although the sizes were considerably different, similarly to the 3YZ ceramic, grains exhibited polyhedral shapes with variations in diameter. The discrepancy in grain growth evolution between 3YZ and 8YZ can be attributed to the difference in grain growth activation energies, which is 105 kcal/mol for tetragonal zirconia and 69 kcal/mol for cubic zirconia. In general, achieving ultrafine grain sizes for 8YZ is a more delicate procedure than for 3YZ.

### Example 2

In another example, sintering kinetics for grain growth may vary for the hydrothermally dried compact ceramic compared with the more traditional powder compacted ceramic. In this example, the geometric factors comparing the dried compact to the powder compacted 8YZ varied along the grain boundaries of the green body. In this regard, as pores were not significantly present within the grains of the dried compact 8YZ, densification was found to be controlled by grain boundary diffusion during sintering. Without wishing to be bound by any theory, in some cases, it is believed that during the final stage of sintering, grain growth can be given by the following relative coarsening/densification ratio gamma (Γ):

$$Γ = \frac{3}{176} \frac{ω {D}_{s}}{δ {D}_{gb}} \frac{{γ}_{gb}}{{γ}_{s}}$$

Here, Dₛ and D_{gb} refer to surface and grain boundary diffusivities, respectively, gammaₛ (γₛ) and gamma_{gb} (γ_{gb}) are surface and grain boundary energies, respectively, and omega (ω) and delta (δ) are the effective widths of surface and grain boundary diffusion, respectively. As it can be assumed that the surface and grain boundary diffusivities and energies are fixed values for a given system, the geometric values omega and delta are the main variables. Further examination of these two values suggests that omega should also be a fixed value for both the 8YZ dried compact intermediate and the powder compacted intermediate. In some embodiments of the present invention, the coarsening/densification ratio for the 8YZ dried compact ceramic is between approximately 3 to approximately 6 times greater than that of 8YZ powder compacted ceramic. As a result, the grain boundary diffusion width in the 8YZ powder compacted ceramic would result in being approximately 3 to approximately 6 times that of 8YZ dried compact ceramic.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention. All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for synthesizing a densified metal oxide comprising:
providing a metal hydroxide suspension;
hydrothermally treating the metal hydroxide suspension, forming a metal oxide suspension;
drying the metal oxide suspension and recovering a dried metal oxide green body; and
in the absence of a step of powder compacting between the hydrothermal treatment step and sintering, sintering the dried metal oxide green body by exposing the green body to a sintering environment at less than 1300° C. and less than 50 MPa to form a densified metal oxide ceramic at greater than 96% relative density.

2. The method of claim 1, wherein sintering the dried metal oxide green body by exposing the green body to a sintering environment comprises exposing the green body to a sintering environment at less than 1200° C.

3. The method of claim 1, wherein sintering the dried metal oxide green body by exposing the green body to a sintering environment comprises exposing the green body to a sintering environment at less than 1100° C.

4. The method of claim 1, wherein sintering the dried metal oxide green body by exposing the green body to a sintering environment comprises exposing the green body to a sintering environment at less than 1000° C.

5. The method of claim 1, wherein sintering the dried metal oxide green body by exposing the green body to a sintering environment comprises exposing the green body to a sintering environment at near atmospheric pressure levels.

6. The method of claim 1, further comprising a step of washing before drying the metal oxide suspension and recovering the dried metal oxide green body.

7. A densified metal oxide comprising:
a nanostructured tetragonal or cubic material, wherein the nanostructured material has a relative density of at least 96% and an average grain size of less than 100 nm.

8. The densified metal oxide of claim 7, wherein the nanostructured material comprises a nanocrystalline material.

9. The densified metal oxide of claim 7, wherein the nanostructured material comprises a relative density of at least 98%.

10. The densified metal oxide of claim 7, wherein the nanostructured material comprises a relative density of at least 99%.

11. The densified metal oxide of claim 7, wherein the nanostructure material comprises an average grain size of less than 500 nm.

12. The densified metal oxide of claim 7, wherein the nanostructure material comprises an average grain size of less than 1000 nm.

13. The densified metal oxide of claim 7, wherein the nanostructure material comprises an average grain size of less than 1 μm.

14. The densified metal oxide of claim 7, wherein the nanostructure material comprises a 3YZ material.

15. The densified metal oxide of claim 7, wherein the nanostructure material comprises a 8YZ material.

16. A method for synthesizing a densified metal oxide comprising:
providing a ceramic precursor composition; and
sintering the ceramic precursor composition by exposing the composition to a sintering environment at less than 1300° C. and less than 50 MPa to form a densified metal oxide ceramic at greater than 96% relative density.

17. The method of claim 16, wherein sintering the ceramic precursor composition by exposing the composition to a sintering environment comprises exposing the composition to a sintering environment at less than 1200° C.

18. The method of claim 16, wherein sintering the ceramic precursor composition by exposing the composition to a sintering environment comprises exposing the composition to a sintering environment at near atmospheric pressure levels.
